(19) United States
(12) Patent Application Publication
(10) Pub. No.: US 2025/0315737 A1
(43) Pub. Date: Oct. 9, 2025

(54) METHOD FOR TRAINING LARGE LANGUAGE MODEL, TEXT QUERY METHOD AND APPARATUS THEREOF

(71) Applicant: BEIJING BAIDU NETCOM SCIENCE TECHNOLOGY CO., LTD., Beijing (CN)

(72) Inventors: Yilin Wen, Beijing (CN); Zhonghou Lv, Beijing (CN); Wenhua Wang, Beijing (CN); Meng Li, Beijing (CN); Weijuan Tian, Beijing (CN); Guoqiu Wang, Beijing (CN)

(73) Assignee: BEIJING BAIDU NETCOM SCIENCE TECHNOLOGY CO., LTD., Beijing (CN)

(21) Appl. No.: 19/245,054

(22) Filed: Jun. 20, 2025

(30) Foreign Application Priority Data
Jan. 23, 2025 (CN) 202510112818.0

(51) Int. Cl. G06N 20/00; G06F 40/279; G06F 40/40

(52) U.S. Cl. CPC G06N 20/00; G06F 40/279; G06F 40/40

(57) ABSTRACT

The disclosure provides a method for training a large language model. The method includes: determining a sample query text, and obtaining at least one set of prompt samples related to the sample query text from a preset index pool, in which the index pool includes a plurality of sets of candidate samples, and the set of candidate samples includes a positive sample and a negative sample; obtaining a sample answer text by inputting the set of prompt samples and the sample query text into a large language model to be trained; obtaining an accuracy-related parameter of the sample answer text, and updating the index pool according to the accuracy-related parameter; and obtaining a target large language model by incrementally training the large language model based on the index pool updated.

### CROSS REFERENCE TO RELATED APPLICATIONS

This application claims priority and benefits to Chinese Application No. 2025101128180, filed on Jan. 23, 2025, the entire content of which is incorporated herein by reference.

### TECHNICAL FIELD

The disclosure relates to the field of artificial intelligence, and in particular to the field of deep learning, natural language processing and large models, and specifically relates to a method for training a large language model, a text query method and an apparatus thereof.

### BACKGROUND

Large Language Model (LLM) is a kind of natural language processing models based on deep learning technology, with extremely high language understanding and generation capabilities. With the improvement of computing power and the accumulation of large-scale data, currently, LLMs have been widely used in recent years, including text generation, machine translation, automatic question and answer, information retrieval and other fields.

### SUMMARY

The disclosure provides a method for training a LLM, a text query method, an apparatus, a device and a storage medium.

According to a first aspect of the disclosure, a method for training a LLM is provided. The method includes: determining a sample query text, and obtaining at least one set of prompt samples related to the sample query text from a preset index pool by matching, wherein the index pool comprises a plurality of sets of candidate samples, and each of the sets of the candidate samples comprises a positive sample and a negative sample; obtaining a sample answer text by inputting the set of prompt samples and the sample query text into a large language model to be trained; obtaining an accuracy-related parameter of the sample answer text, and updating the index pool according to the accuracy-related parameter; and obtaining a trained target large language model by incrementally training the large language model based on the index pool updated.

According to a second aspect of the disclosure, a text query method is provided. The method includes: obtaining a target query text; obtaining at least one set of target prompt samples related to the target query text from a target index pool by matching, wherein the target index pool comprises a plurality of sets of candidate samples, and each of the sets of candidate samples comprises a positive sample and a negative sample; obtaining a pending answer text by inputting the set of target prompt samples and the target query text into a target large language model; and determining a target answer text corresponding to the target query text according to the pending answer text.

According to a third aspect of the disclosure, an electronic device is provided. The electronic device includes: at least one processor, and a memory communicatively connected to the at least one processor. The memory stores instructions executable by the at least one processor, and the instructions are executed by the at least one processor to cause the at least one processor to implement the method for training a LLM or the text query method.

According to a fourth aspect of the disclosure, a non-transitory computer readable storage medium having computer instructions stored thereon is provided. The computer instructions are used to cause a computer to implement the method for training a LLM or the text query method.

According to a fifth aspect of the disclosure, a computer program product including computer programs is provided. When the computer programs are executed by a processor, the method for training a LLM or the text query method is implemented.

It should be understood that the content described in the section is not intended to identify key or important features of the embodiments of the disclosure, nor is it intended to limit the scope of the disclosure. Additional features of the disclosure will be easily understood from the following description.

### BRIEF DESCRIPTION OF THE DRAWINGS

The accompanying drawings are used to better understand the solution and do not constitute a limitation to the disclosure, in which:

FIG. 1 is a schematic diagram of an exemplary implementation of a method for training a LLM according to an exemplary embodiment of the disclosure.

FIG. 2 is a schematic diagram of a preset index pool according to an exemplary embodiment of the disclosure.

FIG. 3 is a schematic diagram of an exemplary implementation of a method for training a LLM according to an exemplary embodiment of the disclosure.

FIG. 4 is a schematic diagram of an exemplary implementation of a method for training a LLM according to an exemplary embodiment of the disclosure.

FIG. 5 is a schematic diagram of an exemplary implementation of a text query method according to an exemplary embodiment of the disclosure.

FIG. 6 is a schematic diagram of an exemplary implementation of a text query method according to an exemplary embodiment of the disclosure.

FIG. 7 is a schematic diagram of an apparatus for training a LLM according to an exemplary embodiment of the disclosure.

FIG. 8 is a schematic diagram of a text query apparatus according to an exemplary embodiment of the disclosure.

FIG. 9 is a schematic diagram of an electronic device according to an exemplary embodiment of the disclosure.

### DETAILED DESCRIPTION

Exemplary embodiments of the disclosure are described below with reference to the accompanying drawings, in which various details of the embodiments of the disclosure are included to facilitate understanding, and they should be considered as exemplary only. Therefore, those skilled in the art should realize that various changes and modifications can be made to the embodiments described herein without departing from the scope and spirit of the disclosure. For clarity and brief, descriptions of well-known functions and structures are omitted in the following descriptions.

Deep learning (DL), is a new research direction in the field of machine learning (ML), which has been introduced into ML to bring it closer to its original goal of artificial intelligence. DL is the process of learning the intrinsic laws and representation hierarchies of sample data, and the information gained from the learning process can be very helpful in the interpreting of data such as text, images and sounds. Its ultimate goal is to make machines capable of analytical learning capabilities like humans, capable of recognizing data such as text, images and sounds. DL is a complex ML algorithm that has achieved results in speech and image recognition that far exceed previous related techniques.

Artificial intelligence (AI) is the study of making computers to simulate certain thought processes and intelligent behaviors of human beings (e.g., learning, reasoning, thinking, planning, etc.), which includes techniques both at the hardware level and at the software level. AI hardware technology generally includes computer vision technology, speech recognition technology, natural language processing technology and its learning/DL, big data processing technology, knowledge graph technology and other major aspects.

Natural language processing (NLP) is an important branch of the field of AI, and it aims to enable computers to understand, generate and interact with human language. It involves multiple disciplines, including linguistics, computer science and mathematics, and aims to enable computers to process and analyze large amounts of natural language data (e.g., text, speech, etc.) The goal of NLP is to enable computers to understand the meaning of language in the same way that humans do, so as to realize intelligent interaction with humans.

In the technical solution of the disclosure, acquisition, storage and application of personal information of users are all in compliance with provisions of relevant laws and regulations, and do not violate public order and good customs.

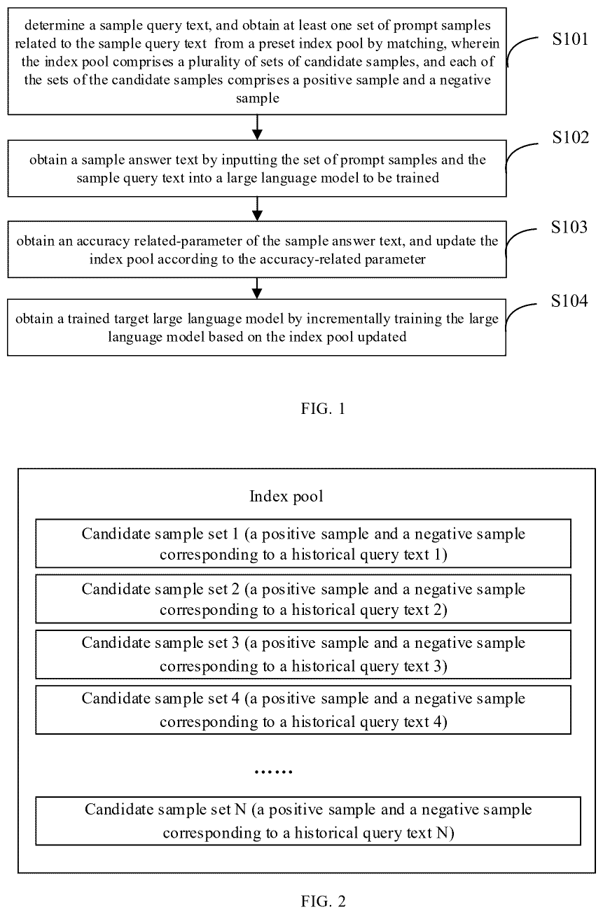

FIG. 1 is a schematic diagram of an exemplary implementation of a method for training a LLM illustrated in the disclosure. As illustrated in FIG. 1, the method for training a LLM includes the following steps.

At step S101, a sample query text is determined, and at least one set of prompt samples related to the sample query text is obtained from a preset index pool by matching, in which the index pool includes a plurality of sets of candidate samples, and each of the sets of candidate samples includes a positive sample and a negative sample.

For the convenience of understanding, FIG. 2 is a schematic diagram of a preset index pool illustrated in the disclosure. As illustrated in FIG. 2, the preset index pool includes N sets of candidate samples, and each of the sets of the candidate samples includes a positive sample and a negative sample. For example, a candidate sample set 1 includes a positive sample (which is generated based on a historical query text 1 and a correct answer corresponding to the historical query text 1) corresponding to the historical query text land a negative sample (which is generated based on the historical query text 1 and a wrong answer corresponding to the historical query text 1) corresponding to the historical query text 1. A candidate sample set 2 includes a positive sample and a negative sample corresponding to a historical query text 2, and so on.

In the disclosure, the number of positive samples and the number of negative samples included in each set of candidate samples are not limited.

In the disclosure, the number of the sets of prompt samples matched to can be set as appropriate.

In the disclosure, firstly, it is necessary to determine a sample query text. Optionally, the sample query text may be a text entered by a user when performing the query online. That is, the model is trained based on online data.

After determining the sample query text, at least one set of prompt samples related to the sample query text is obtained from the preset index pool by matching. For example, for a certain sample query text, there may be five sets of prompt samples corresponding to the sample query text, namely, a candidate sample set 1, a candidate sample set 3, a candidate sample set 5, a candidate sample set 8 and a candidate sample set 9.

At step S102, a sample answer text is obtained by inputting the set of prompt samples and the sample query text into a LLM to be trained.

After determining the set of prompt samples corresponding to the sample query text, the set prompt samples is used as a prompt of the sample query text and input to the LLM to be trained together with the sample query text, to obtain the sample answer text corresponding to the sample query text output by the LLM.

At step S103, an accuracy-related parameter of the sample answer text is obtained, and the index pool is updated according to the accuracy-related parameter.

In the disclosure, updating the index pool includes: adding a new set of candidate samples to the index pool or keeping the current index pool unchanged. That is, it is understood that in the disclosure, adding a new set of candidate samples to the index pool and keeping the current index pool unchanged both are regarded as operations of updating the index pool.

As a realizable implement, after obtaining the sample answer text corresponding to the sample query text, it is determined whether the sample answer text is correct (i.e., whether the sample answer text solves the problem raised by the sample query text), and if the sample answer in text is determined to be correct, it means that the current LLM is able to accurately understand and answer the sample query text, and at this time, keep the current index pool remains unchanged.

As another realizable approach, after obtaining the sample answer text corresponding to the sample query text, it is determined whether the sample answer text is correct. If the sample answer text is determined to be wrong, it means that the current LLM cannot accurately understand and answer the sample query text. In order to improve the capability of the model, it is necessary to create a negative sample corresponding to the sample query text based on the sample query text and the sample answer text, and re-input the set of prompt samples and the sample query text into the LLM to obtain a new sample answer text, and then determine whether the new sample answer text is correct or not. If the new sample answer text is determined to be correct, create a positive sample corresponding to the sample query text based on the sample query text and the new sample answer, and create a set of candidate samples corresponding to the sample query text based on the positive sample in combination with the previously created negative sample corresponding to the sample query text and add the set of candidate samples into the index pool. If the new sample answer texts obtained are determined to be wrong several times, a correct answer text corresponding to the sample query text can be marked manually, and a positive sample is created based on the sample query text and its corresponding correct answer text, and a set of candidate samples corresponding to the sample query text is created based on the positive sample in combination with the previously created negative sample and added to the index pool.

At step S104, a target LLM is obtained by incrementally training the LLM based on the index pool updated.

After updating the index pool, a second sample query text is obtained, and the steps S101-S103 are performed repeatedly on the basis of the index pool updated based on the second sample query text to obtain a newly index pool updated, and then a third sample query text is obtained sequentially, and so on. Incremental training of the model is carried out until the training is completed, and the trained target LLM is obtained. The trained target LLM can be used to obtain more accurate answer text for a query text. For example, a text actually entered by users online is used as a target query text, and based on the target query text and at least one set of target prompt samples related to the target query text, a target answer text corresponding to the target query text can be obtained by using the trained target LLM.

The embodiment of the disclosure provides a method for training a LLM. The method includes: determining a sample query text, and obtaining at least one set of prompt samples related to the sample query text from a preset index pool by matching, in which the index pool includes a plurality of sets of candidate samples, and the set of candidate samples includes a positive sample and a negative sample; obtaining a sample answer text by inputting the set of prompt samples and the sample query text into a LLM to be trained; obtaining an accuracy-related parameter of the sample answer text, and updating the index pool according to the accuracy-related parameter; and obtaining a target LLM by incrementally training the LLM based on the index pool updated. In the disclosure, when the related set of prompt samples and the sample query text are input into the LLM, the model can learn a reward function invisibly based on the positive and negative samples in the set of prompt samples, so as to generate more accurate answers. By incrementally training based on the index pool updated instead of training the whole model from scratch, it can significantly reduce the cost of computational resources and time, and further improve the quality of the model more efficiently.

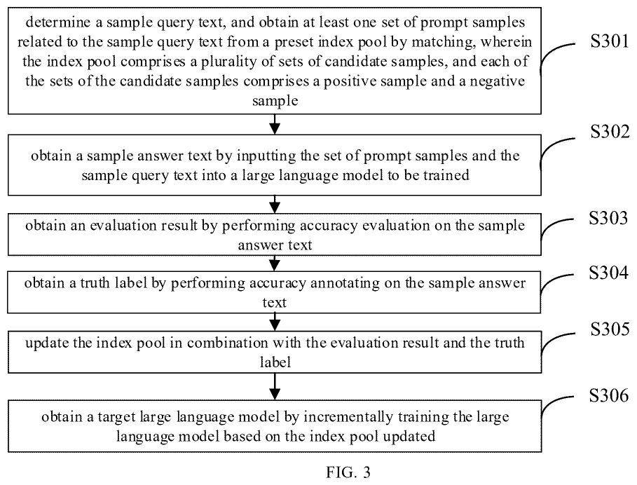

FIG. 3 is a schematic diagram of an exemplary implementation of a method for training a LLM illustrated in the disclosure. As illustrated in FIG. 3, the method for training a LLM includes the following steps.

At step S301, a sample query text is determined, and at least one set of prompt samples related to the sample query text is obtained from a preset index pool by matching, in which the index pool includes a plurality of sets of candidate samples, and the set of candidate sample includes a positive sample and a negative sample.

In some embodiments, a plurality of first sets of initial samples related to the sample query text are obtained from the index pool by matching based on a term frequency-inverse document frequency algorithm (BM25 algorithm). A first vector similarity between the sample query text and each one of the first sets of initial samples then determined, and a set of prompt samples related to the sample query text is selected from the first sets of initial samples based on the first vector similarity. For example, the first vector similarities are ranked in a descending order, and the first sets of initial samples corresponding to the first k first vector similarities are determined as the sets of prompt samples related to the sample query text.

Calculating the first vector similarity between the sample query text and each one of the first sets of initial samples includes: converting the sample query text into a first text vector; converting each of the first sets of initial samples into a second text vector; and calculating a vector similarity between the first text vector and each second text vector, respectively, as a first vector similarity.

BM25 algorithm has a higher computational efficiency in obtaining the set of prompt samples related to the sample query text through matching, and is able to quickly select the first sets of initial samples from the index pool, which can reduce the time for selecting and processing. By calculating the first vector similarity between the sample query text and each one of the first sets of initial samples, it is possible to more accurately select the sets of prompt samples that are highly relevant to the query text at the semantic level. The combination of the matching and calculating makes it possible to efficiently select sets of prompt samples while enhancing a semantic matching ability, thereby improving the effect of subsequent training.

The number of the first sets of initial samples is determined based on an input length limit of the LLM and a threshold of the term frequency-inverse document frequency algorithm. For example, a first parameter k is determined based on the input length limit of the LLM, and a second parameter w is determined based on the threshold of the term frequency-inverse document frequency algorithm, so that the number of first sets of initial samples is w×k. It is not difficult to understand that the number of the sets of prompt samples related to the sample query text selected from the first sets of initial samples based on the first vector similarities is less than w×k, and the final number of the sets of prompt samples related to the sample query text can be set to k.

At step S302, a sample answer text is obtained by inputting the set of prompt samples and the sample query text into a LLM to be trained.

At step S303, an evaluation result is obtained by performing accuracy evaluation on the sample answer text.

As another realizable implementation, the sample query text and the sample answer text are input into a pre-trained accuracy evaluation model to obtain the evaluation result of the sample answer text.

As another realizable implementation at least one set of evaluation samples related to the sample answer text is obtained from the index pool by matching. For example, in FIG. 2, the determined sets of evaluation samples may be a candidate sample set 2, a candidate sample set 3, a candidate sample set 4, a candidate sample set 5 or a candidate sample set 6. By performing accuracy evaluation on the sample answer text based on the sets of evaluation sample, the evaluation result is obtained.

In some embodiments, obtaining at least one set of evaluation samples related to the sample answer text from the index pool by matching, includes: obtaining a plurality of second sets of initial samples related to the sample answer text by matching from the index pool based on a term frequency-inverse document frequency algorithm; and calculating a second vector similarity between the sample answer text and each one of the second sets of initial samples, and selecting a set of evaluation samples related to the sample answer text from the second sets of initial samples based on the second vector similarity. For example, the second vector similarities are ranked in a descending order, and the second sets of initial samples corresponding to the first k second vector similarities are determined as the sets of evaluation samples related to the sample answer text.

Calculating the second vector similarity between the sample answer text and each one of the second sets of initial samples, includes: converting the sample answer text into a first text vector; converting each of the sets of second initial samples related to the sample answer text into a second text vector respectively; and calculating a vector similarity between the first text vector and each second text vector as a second vector similarity.

BM25 algorithm has a higher computational efficiency in obtaining the set of evaluation sample related to the sample answer text, and is able to quickly select the second sets of initial samples from the index pool, which can reduce the time for selecting and processing. By calculating the second vector similarity between the sample answer text and each of the second sets of initial samples, it is possible to more accurately select the sets of evaluation samples that are highly related to the sample answer text at the semantic level.

The number of the sets of evaluation samples may be set according to the actual situation. The number of the sets of evaluation samples may be the same as or different from the number of the sets of prompt samples related to the sample query text.

Obtaining the evaluation result by performing accuracy evaluation on the sample answer text based on the set of evaluation samples includes: obtaining the evaluation result output by the LLM by inputting the sample answer text and the set of evaluation samples into the LLM. In this way, the final trained target LLM not only improves the reasoning performance of obtaining the answer text, but also improves the evaluation performance of evaluating the answer text.

At step S304, performing accuracy labeling on the sample answer text to obtain a truth label.

The truth label can be considered as the most accurate label.

At step S305, the index pool is updated in combination with the evaluation result and the truth label.

In the disclosure, the updating operation of the index pool include: adding a new set of candidate samples to the index pool and keeping the current index pool unchanged.

In some embodiments, if the evaluation result is consistent with the truth label and they both indicate that the sample answer text is correct, it means that the current LLM has been able to accurately understand and answer the sample query text, and thus the current index pool is kept unchanged, and the next training can be conducted based on the next sample query text in combination with the current index pool.

In some embodiments, if the evaluation result is inconsistent with the truth label, the evaluation result indicates that the sample answer text is wrong, but the truth label indicates that the sample answer text is correct, the sample answer text is considered to be correct according to the truth label. At this time, it is also considered that the current LLM is able to accurately understand and answer the sample query text, and thus the current index pool is kept unchanged, and the next training can be conducted based on the next sample query text in combination with the current index pool.

In some embodiments, if the evaluation result is inconsistent with the truth label, the evaluation result indicates that the sample answer text is correct, but the truth label indicates that the sample answer text is wrong, the sample answer text is considered to be wrong according to the truth label. A negative sample is created based on the sample query text and its corresponding sample answer text and is stored in a cache area, and a positive sample created manually based on the sample query text and its corresponding correct answer is obtained in time, so that a new set of candidate samples can be created based on the positive sample and the negative sample of the sample query text and added to the current index pool.

In some embodiments, if the evaluation result is consistent with the truth label and they both indicate that the sample answer text is wrong, it indicates that the current LLM cannot accurately understand and answer the sample query text. A negative sample is created based on the sample query text and its corresponding sample answer text and stored in a cache area (the negative sample is a meaningful negative sample and helps to improve model capability). The sample query text and its corresponding set of prompt samples are re-input into the LLM to re-obtain the sample answer text corresponding to the sample query text for the second time. If the evaluation result corresponding to the sample answer text for the second time is consistent with the truth label and they both indicate that the sample answer text is correct, a positive sample corresponding to the sample query text is created based on the sample query text and the sample answer text for the second time, and a new set of candidate samples is created based on the positive sample in combination with the negative sample generated at the first time of evaluation and added to the current index pool. If the evaluation result corresponding to the sample answer text obtained at the second time of evaluation and the truth label do not indicate that the sample answer text is correct, a sample answer text corresponding to the sample query text is obtained at the third time, and so on. If, after N times, for the sample answer text obtained of N times, there is never a situation where the evaluation result and the truth label are consistent and both indicate that the sample answer text is correct, then the negative samples corresponding to the sample query text at the N time are saved, and the positive sample manually generated based on the sample query text and its corresponding correct answer can be obtained in due course, and a new set of candidate sample sets is created based on the positive sample and the negative sample of the sample query text and added to the current index pool.

At step S306, a trained target LLM is obtained by incrementally training the LLM based on the index pool updated.

In the embodiment of the disclosure, when the related set of prompt samples and the sample query text are input into the LLM, the model can learn a reward function invisibly based on the positive and negative samples in the set of prompt samples, so as to generate more accurate answers. By adding the symbolic positive and negative samples to the index pool based on the joint decision of the evaluation result and the truth label, the index pool can subsequently guide the LLM to generate more accurate answer texts. By incrementally training based on the index pool updated instead of training the whole model from scratch, it can greatly reduce the cost of computational resources and time, and further improve the quality of the model more efficiently.

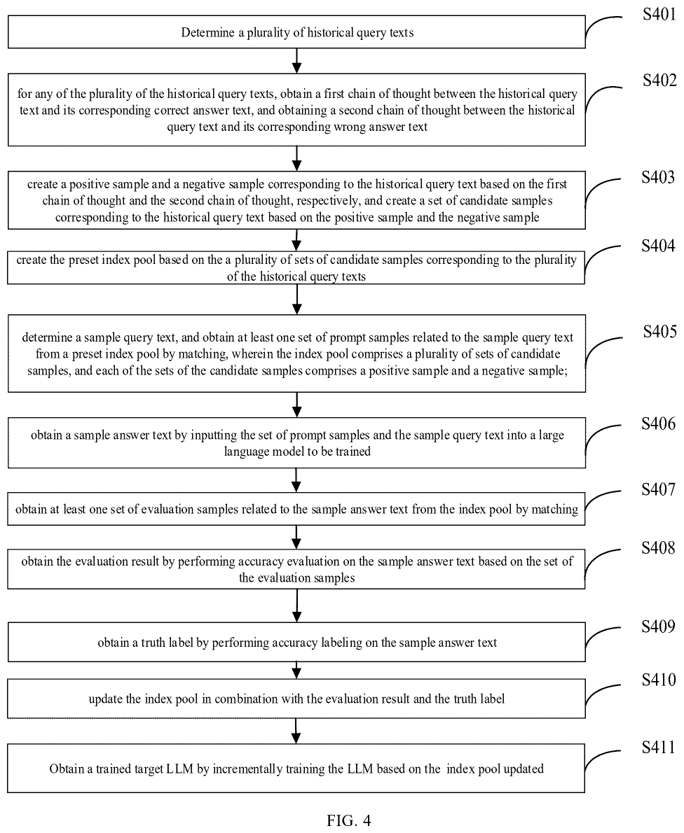

FIG. 4 is a schematic diagram of an exemplary implementation of a method for training a LLM according to an exemplary embodiment of the disclosure. As illustrated in FIG. 4, the method includes the following steps.

At step S401, a plurality of historical query texts are determined.

At step S402, for any of the plurality of the historical query texts, a first chain of thought between the historical query text and its corresponding correct answer text is obtained, and a second chain of thought between the historical query text and its corresponding wrong answer text is obtained.

Each chain of thought is represented by a trajectory sequence s1, a1, s2, a2, . . . , which follows the Markov assumption that the future state only depends on the current state and has nothing to do with the past state. Its structure is illustrated below, in which
s1 refers to a description of a query: the state represents the input historical query text and is the starting point of the whole reasoning process;
a1 refers to Plan 1: this is the first reasoning or planning step based on s1, which is usually manifested as a preliminary analysis of the query to provide a guidance for generating an answer next;
s2 refers to an answer generated according to the description of the query+Plan 1+the answer generated by the LLM according to calculation 1. Under this state, the historical query text is combined with the first reasoning step, and a preliminary answer is generated after reasoning in the LLM; and
a2 refers to Plan 2, which is used for subsequent planning and modification. This is the next reasoning or modification step based on s2, which may involve modifying the preliminary answer or further reasoning and aims at optimizing the answer of the model, and so on.

At step S403, a positive sample and a negative sample corresponding to the historical query text are created based on the first chain of thought and the second chain of thought, respectively, and a set of candidate samples is created corresponding to the historical query text based on the positive sample and the negative sample.

Both positive and negative samples include the whole chain of thought and a positive or negative sample label.

At step S404, the preset index pool is created based on the sets of candidate samples corresponding to each of the plurality of the historical query texts.

Generally, the current preset index pool does not contain too many sets of candidate samples, and the index pool will be incrementally expanded in the subsequent incremental training process.

At step S405, a sample query text is determined, and at least one sets of prompt samples related to the sample query text is obtained from a preset index pool by matching, in which the index pool includes a plurality of sets of candidate samples, and the set of candidate samples includes a positive sample and a negative sample.

At step S406, a sample answer text is obtained by inputting the set of prompt samples and the sample query text into a LLM to be trained.

At step S407, at least one set of evaluation samples related to the sample answer text is obtained from the index pool by matching.

At step S408, an evaluation result is obtained by performing accuracy evaluation on the sample answer text based on the set of evaluation samples.

At step S409, a truth label is obtained by performing accuracy annotating on the sample answer text.

At step S410, the index pool is updated in combination with the evaluation result and the truth label.

At step S411, a trained target LLM is obtained by incrementally training the LLM based on the index pool updated.

The specific implementations of steps S405-S411 can refer to the specific introduction of relevant parts in the above-mentioned embodiments, and will not be repeated here.

The embodiment of the disclosure introduces how the index pool is pre-created, and the usage of the chain of thought enables the set of candidate samples to include more information. When the related set of prompt samples and the sample query text are input into the LLM, the model can learn a reward function invisibly based on the positive and negative samples in the set of prompt samples, so as to generate more accurate answers, By adding the symbolic positive and negative samples to the index pool based on the joint decision of the evaluation result and the truth label, the index pool can subsequently guide the LLM to generate more accurate answer texts in the future. By incrementally training based on the index pool updated instead of training the whole model from scratch, it can greatly reduce the cost of computational resources and time, and further improve the quality of the model more efficiently.

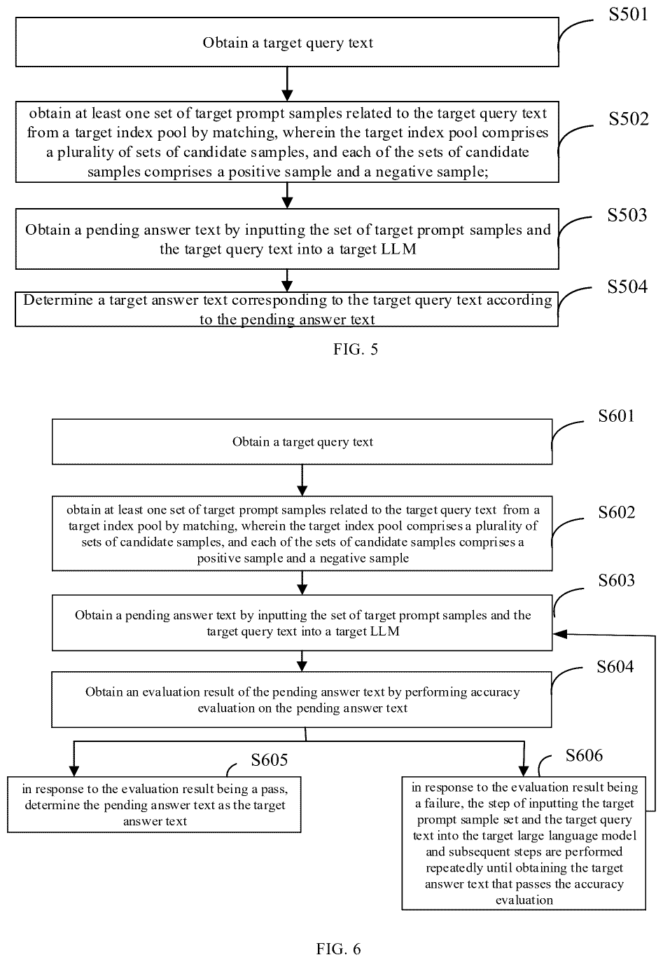

FIG. 5 is a schematic diagram of an exemplary implementation of a text query method according to an exemplary embodiment of the disclosure. As illustrated in FIG. 5, the method includes the following steps.

At step S501, a target query text is obtained.

Generally, the target query text is a text actually entered by users online.

At step S502, at least one set of target prompt samples related to the target query text is obtained from a target index pool by matching, in which the target index pool includes a plurality of sets of candidate samples, and the set of candidate samples includes a positive sample and a negative sample.

In some embodiments, a plurality of sets of initial samples related to the target query text are obtained from the target index pool by matching based on the term frequency-inverse document frequency algorithm (BM25 algorithm). A set of target prompt samples related to the target query text is selected from the sets of initial samples based on a vector similarity between the target query text and each set of initial samples.

At step S503, a pending answer text is obtained by inputting the set of target prompt samples and the target query text into a target LLM.

The target LLM is trained and generated by the training method introduced in the above embodiment.

At step S504, a target answer text corresponding to the target query text is determined according to the pending answer text.

As a realizable implement, after obtaining the pending answer text, the pending answer text is edited and modified adaptively to obtain the final target answer text.

As another realizable implement, the pending answer text may be directly used as the target answer text, to reduce the amount of calculation.

The embodiment of the disclosure provides a text query method. The method includes: obtaining a target query text; obtaining at least one set of target prompt samples related to the target query text from a target index pool by matching, in which the target index pool includes a plurality of sets of candidate samples, and the set of candidate samples includes a positive sample and a negative sample; obtaining a pending answer text by inputting the set of target prompt samples and the target query text into a target LLM; and determining a target answer text corresponding to the target query text according to the pending answer text. In the disclosure, when the related set of target prompt samples and the target query text are input into the target LLM that is fully trained, the target LLM can learn a reward function invisibly based on the positive and negative samples in the set of target prompt samples, so as to generate more accurate answer texts.

FIG. 6 is a schematic diagram of an exemplary implementation of a text query method according to an exemplary embodiment of the disclosure. As illustrated in FIG. 6, the method includes the following steps.

At step S601, a target query text is obtained.

At step S602, at least one set of target prompt samples related to the target query text is obtained from a target index pool by matching, in which the target index pool includes a plurality of sets of candidate samples, and the set of candidate samples includes a positive sample and a negative sample.

At step S603, a pending answer text is obtained by inputting the set of target prompt samples and the target query text into a target LLM.

The specific implementations of steps S601-S603 can refer to the specific introduction of relevant parts in the above-mentioned embodiments, and will not be repeated here.

At step S604, an evaluation result of the pending answer text is obtained by performing accuracy evaluation on the pending answer text.

As a realizable implement, the pending answer text and the target query text are input into a pre-trained accuracy evaluation model, to obtain the evaluation result of the pending answer text.

As another realizable implement, at least one set of target evaluation samples related to the pending answer text is obtained from the index pool by matching. The evaluation result of the pending answer text is obtained by performing accuracy evaluation on the pending answer text based on the set of target evaluation sample.

At step S605, in response to the evaluation result being a pass, the pending answer text is determined as the target answer text.

At step S606, in response to the evaluation result being a failure, the step of inputting the set of target prompt samples and the target query text into the target large language model and subsequent steps are performed repeatedly until obtaining the target answer text that passes the evaluation.

In the disclosure, when the related set of target prompt samples and the target query text are input into the target LLM that is fully trained, the target LLM can learn a reward function invisibly based on the positive and negative samples in the set of target prompt samples, so as to generate more accurate answer texts. By evaluating the generated pending answer text, the final target answer text presented to the user is a highly accurate answer text, which improves user satisfaction.

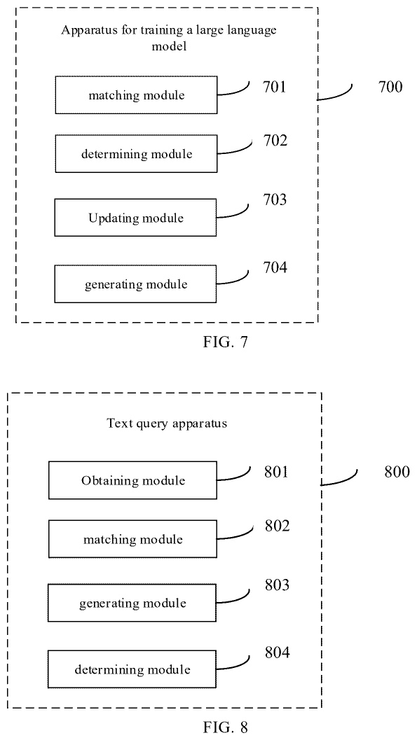

FIG. 7 is a schematic diagram of an apparatus 700 for training a LLM according to an exemplary embodiment of the disclosure. As illustrated in FIG. 7, the apparatus 700 includes:
a matching module 701, configured to determine a sample query text, and obtain at least one set of prompt samples related to the sample query text from a preset index pool by matching, in which the index pool includes a plurality of sets of candidate samples, and the set of candidate samples includes a positive sample and a negative sample;
a determining module 702, configured to obtain a sample answer text by inputting the set of prompt samples and the sample query text into a LLM to be trained;
an updating module 703, configured to obtain an accuracy-related parameter of the sample answer text, and update the index pool according to the accuracy-related parameter; and
a first generating module 704, configured to obtain a trained target LLM by incrementally training the LLM based on the index pool updated.

With the apparatus, when the related set of prompt samples and the sample query text are input into the LLM, the model can learn a reward function invisibly based on the positive and negative samples in the set of prompt samples, so as to generate more accurate answers. By incrementally training based on the index pool updated instead of training the whole model from scratch, it can greatly reduce the cost of computational resources and time, and further improve the quality of the model more efficiently.

The updating module 703 is further configured to: obtain an evaluation result by performing accuracy evaluation on the sample answer text; obtain a truth label by performing accuracy labeling on the sample answer text; and update the index pool in combination with the evaluation result and the truth label.

The updating module 703 is further configured to: obtain at least one set of evaluation samples related to the sample answer text from the index pool by matching; and obtain the evaluation result by performing accuracy evaluation on the sample answer text based on the set of evaluation samples.

The matching module 701 is further configured to: obtain a plurality of first sets of initial samples related to the sample query text from the index pool by matching based on a term frequency-inverse document frequency algorithm; and calculate a first vector similarity between the sample query text and each one of the first sets if initial samples, and select a set of prompt samples 4related to the sample query text from the first sets of initial samples based on the first vector similarity.

The updating module 703 is further configured to: obtain a plurality of second sets of initial samples related to the sample answer text from the index pool by matching based on a term frequency-inverse document frequency algorithm; and calculate a second vector similarity between the sample answer text and each one of the second sets of initial samples, and select a set of evaluation samples related to the sample answer text from the second sets of initial samples based on the second vector similarity.

The matching module 701 and the updating module 703 are further configured to: convert any sample text of the sample query text and the sample answer text into a first text vector; convert a set of initial samples corresponding to the any sample text into a second text vector; and calculate a vector similarity between the first text vector and the second text vector.

The apparatus 700 further includes: a creating module. The creating module is configured to: determine a plurality of historical query texts; for any of the plurality of historical query texts, obtain a first chain of thought between the historical query text and its corresponding correct answer text, and obtain a second chain of thought between the historical query text and its corresponding wrong answer text; create a positive sample and a negative sample corresponding to the historical query text based on the first chain of thought and the second chain of thought, respectively, and create a set of candidate samples corresponding to the historical query text based on the positive sample and the negative sample; and create the preset index pool based on the set of candidate samples corresponding to each one of the plurality of historical query texts.

The updating module 703 is further configured to: obtain the evaluation result output by the LLM by inputting the sample answer text and the set of evaluation samples into the LLM.

FIG. 8 is a schematic diagram of a text query apparatus 800 according to an exemplary embodiment of the disclosure. As illustrated in FIG. 8, the apparatus 800 includes:
an obtaining module 801, configured to obtain a target query text;
a matching module 802, configured to obtain at least one set of target prompt samples related to the target query text from a target index pool by matching, in which the target index pool includes a plurality of sets of candidate samples, and the set of candidate samples includes a positive sample and a negative sample;
a generating module 803, configured to obtain a pending answer text by inputting the set of target prompt samples and the target query text into a target large language model; and
a determining module 804, configured to determine a target answer text corresponding to the target query text according to the pending answer text.

With the apparatus, when the related set of target prompt samples and the target query text are input into the trained target LLM, the target LLM can learn a reward function invisibly based on the positive and negative samples in the set of prompt samples, so as to generate more accurate answers.

The second determining module 804 is further configured to: obtain an evaluation result of the pending answer text by performing accuracy evaluation on the pending answer text; in response to the evaluation result being a pass, determine the pending answer text as the target answer text; and in response to the evaluation being a failure, repeatedly perform the step of inputting the set of target prompt samples and the target query text into the target LLM and subsequent steps repeatedly until obtaining the target answer text that passes the evaluation.

The second determining module 804 is further configured to: determine the pending answer text as the target answer text.

According to an embodiment of the disclosure, the disclosure also provides an electronic device, a readable storage medium and a computer program product.

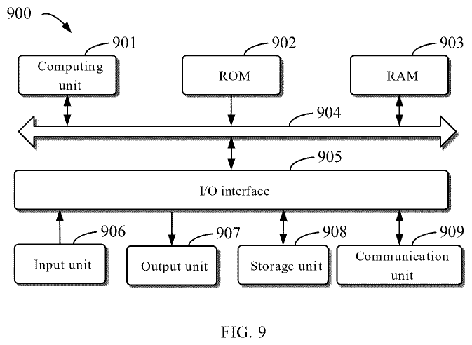

FIG. 9 is a schematic diagram of an electronic device 900 that can be used to implement the embodiment of the disclosure. The electronic device is intended to represent various forms of digital computers, such as a laptop computer, a desktop computer, a workbenches, a personal digital assistant, a server, a blade server, a mainframe computer and other suitable computers. The electronic device may also represent various forms of mobile devices, such as a personal digital processor, a cellular phone, a smart phone, a wearable device and other similar computing devices. The components shown here, their connections and relations, and their functions are merely examples, and are not intended to limit the implementation of the disclosure described and/or required herein.

As illustrated in FIG. 9, the electronic device 900 includes: a computing unit 901 for performing various appropriate actions and processes based on computer programs stored in a Read-Only Memory (ROM) 902 or computer programs loaded from a storage unit 908 to a Random Access Memory (RAM) 903. In the RAM 903, various programs and data required for the operation of the device 900 are stored. The computing unit 901, the ROM 902, and the RAM 903 are connected to each other through a bus 904. An input/output (I/O) interface 905 is also connected to the bus 904.

Components in the device 900 are connected to the I/O interface 905, including: an input unit 906, such as a keyboard and a mouse; an output unit 907, such as various types of displays and speakers; the storage unit 908, such as a disk, an optical disk; and a communication unit 909, such as network cards, modems, and wireless communication transceivers. The communication unit 909 allows the device 900 to exchange information/data with other devices through a computer network such as the Internet and/or various telecommunication networks.

The computing unit 901 may be various general-purpose and/or dedicated processing components with processing and computing capabilities. Some examples of the computing unit 901 include, but are not limited to, a Central Processing Unit (CPU), a Graphics Processing Unit (GPU), various dedicated AI computing chips, various computing units that run machine learning (ML) model algorithms, a Digital Signal Processor (DSP), and any appropriate processor, controller and microcontroller. The computing unit 901 executes the various methods and processes described above, such as the method for training a large language model and the text query method. For example, in some embodiments, each of the above methods may be implemented as a computer software program, which is tangibly contained in a machine readable medium, such as the storage unit 908. In some embodiments, part or all of the computer programs may be loaded and/or installed on the device 900 via the ROM 902 and/or the communication unit 909. When the computer program is loaded on the RAM 903 and executed by the computing unit 901, one or more steps of each of the above methods may be executed. Alternatively, in other embodiments, the computing unit 901 may be configured to perform the above methods in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, a firmware, a software, and/or a combination thereof. These implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processor or controller of a general-purpose computer, a dedicated computer, or other programmable data processing devices, so that when the program code is executed by the processor or controller, the functions/operations specified in the flowchart and/or block diagram can be implemented. The program code may be executed entirely on the machine, partly executed on the machine, partly executed on the machine and partly executed on the remote machine as an independent software package, or entirely executed on the remote machine or server.

In the context of the disclosure, a machine readable medium may be a tangible medium that may contain or store a program for use by or in combination with an instruction execution system, an apparatus, or a device. The machine readable medium may be a machine readable signal medium or a machine readable storage medium. The machine readable medium may include, but is not limited to, an electronic, magnetic, optical, electromagnetic, infrared, or semiconductor system, apparatus or device, or any suitable combination of the above. More specific examples of the machine readable storage medium include electrical connections based on one or more wires, portable computer disks, hard disks, RAMs, ROMs, Electrically Programmable Read-Only-Memories (EPROMs) or flash memories, fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes back-end components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such back-end components, middleware components, and front-end components. The components of the system may be interconnected by any form or medium of digital data communication (e.g., a communication network). The communication network may include, for example, a Local Area Network (LAN), a Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain. It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for training a large language model, performed by an electronic device, comprising:
determining a sample query text, and obtaining at least one set of prompt samples related to the sample query text from a preset index pool by matching, wherein the index pool comprises a plurality of sets of candidate samples, and each of the sets of candidate samples comprises a positive sample and a negative sample;
obtaining a sample answer text by inputting the set of prompt samples and the sample query text into a large language model to be trained;
obtaining an accuracy-related parameter of the sample answer text, and updating the index pool according to the accuracy-related parameter; and
obtaining a trained target large language model by incrementally training the large language model based on the index pool updated.

2. The method of claim 1, wherein obtaining the accuracy-related parameter of the sample answer text, and updating the index pool according to the accuracy-related parameter, comprise:
obtaining an evaluation result by performing accuracy evaluation on the sample answer text;
obtaining a truth label by performing accuracy labeling on the sample answer text; and
updating the index pool in combination with the evaluation result and the truth label.

3. The method of claim 2, wherein obtaining the evaluation result by performing accuracy evaluation on the sample answer text, comprises:
obtaining at least one set of evaluation samples related to the sample answer text from the index pool by matching; and
obtaining the evaluation result by performing accuracy evaluation on the sample answer text based on the set of the evaluation samples.

4. The method of claim 1, wherein obtaining the at least one set of prompt samples related to the sample query text from the preset index pool by matching, comprises:
obtaining a plurality of first sets of initial samples related to the sample query text from the index pool by matching based on a term frequency-inverse document frequency algorithm; and
calculating a first vector similarity between the sample query text and each one of the first sets of the initial samples, and selecting a set of prompt samples related to the sample query text from the first sets of initial samples based on the first vector similarity.

5. The method of claim 3, wherein obtaining at least one set of evaluation samples related to the sample answer text from the index pool by matching, comprises:
obtaining a plurality of second sets of initial samples related to the sample answer text from the index pool by matching based on a term frequency-inverse document frequency algorithm; and
calculating a second vector similarity between the sample answer text and each one of the second sets of initial samples, and selecting a set of evaluation samples related to the sample answer text from the second sets of initial samples based on the second vector similarity.

6. The method of claim 4, wherein calculating the first vector similarity between the sample query text and each one of the first sets of initial samples, or, calculating the second vector similarity between the sample answer text and each one of the second sets of initial samples, comprises:
converting any sample text of the sample query text and the sample answer text into a first text vector;
converting a set of initial samples corresponding to the any sample text into a second text vector; and
calculating a vector similarity between the first text vector and the second text vector.

7. The method of claim 6, wherein the preset index pool is created by:
determining a plurality of historical query texts;
for any of the plurality of historical query texts, obtaining a first chain of thought between the historical query text and its corresponding correct answer text, and obtaining a second chain of thought between the historical query text and its corresponding wrong answer text;
creating a positive sample and a negative sample corresponding to the historical query text based on the first chain of thought and the second chain of thought, respectively, and creating a set of candidate samples corresponding to the historical query text based on the positive sample and the negative sample; and
creating the preset index pool based on the plurality of sets of candidate samples corresponding to the plurality of historical query texts.

8. The method of claim 3, wherein obtaining the evaluation result by performing accuracy evaluation on the sample answer text based on the set of evaluation samples, comprises:
obtaining the evaluation result output by the large language model by inputting the sample answer text and the set of evaluation samples into the large language model.

9. A text query method, performed by an electronic device, comprising:
obtaining a target query text;
obtaining at least one set of target prompt samples related to the target query text from a target index pool by matching, wherein the target index pool comprises a plurality of sets of candidate samples, and each of the sets of candidate samples comprises a positive sample and a negative sample;
obtaining a pending answer text by inputting the set of target prompt samples and the target query text into a target large language model; and
determining a target answer text corresponding to the target query text according to the pending answer text.

10. The method of claim 9, wherein determining the target answer text corresponding to the target query text according to the pending answer text, comprises:
obtaining an evaluation result of the pending answer text by performing accuracy evaluation on the pending answer text;
in response to the evaluation result being a pass, determining the pending answer text as the target answer text; and
in response to the evaluation result being a failure, repeatedly performing the step of inputting the set of target prompt samples and the target query text into the target large language model and subsequent steps until obtaining the target answer text that passes the accuracy evaluation.

11. The method of claim 9, wherein determining the target answer text corresponding to the target query text according to the pending answer text, comprises:
determining the pending answer text as the target answer text.

12. An electronic device, comprising:
at least one processor; and
a memory communicatively connected to the at least one processor;
wherein the at least one processor is configured to:
determine a sample query text, and obtaining at least one set of prompt samples related to the sample query text from a preset index pool by matching, wherein the index pool comprises a plurality of sets of candidate samples, and each of the sets of candidate samples comprises a positive sample and a negative sample;
obtain a sample answer text by inputting the set of prompt samples and the sample query text into a large language model to be trained;
obtain an accuracy-related parameter of the sample answer text, and updating the index pool according to the accuracy-related parameter; and
obtain a trained target large language model by incrementally training the large language model based on the index pool updated.

13. The electronic device of claim 12, wherein obtain the accuracy-related parameter of the sample answer text, and updating the index pool according to the accuracy-related parameter, comprise:
obtain an evaluation result by performing accuracy evaluation on the sample answer text;
obtain a truth label by performing accuracy labeling on the sample answer text; and
update the index pool in combination with the evaluation result and the truth label.

14. The electronic device of claim 13, wherein obtain the evaluation result by performing accuracy evaluation on the sample answer text, comprises:
obtain at least one set of evaluation samples related to the sample answer text from the index pool by matching; and
obtain the evaluation result by performing accuracy evaluation on the sample answer text based on the set of the evaluation samples.

15. The electronic device of claim 12, wherein obtain the at least one set of prompt samples related to the sample query text from the preset index pool by matching, comprises:
obtain a plurality of first sets of initial samples related to the sample query text from the index pool by matching based on a term frequency-inverse document frequency algorithm; and
calculate a first vector similarity between the sample query text and each one of the first sets of the initial samples, and selecting a set of prompt samples related to the sample query text from the first sets of initial samples based on the first vector similarity.

16. An electronic device, comprising:
at least one processor; and
a memory communicatively connected to the at least one processor;
wherein the at least one processor is configured to implement the method of claim 9.

17. A non-transitory computer readable storage medium having computer instructions stored thereon, wherein the computer instructions are used to cause a computer to implement the method of claim1.

18. A non-transitory computer readable storage medium having computer instructions stored thereon, wherein the computer instructions are used to cause a computer to implement the method of claim 9.

19. A computer program product comprising computer programs, wherein when the computer programs are executed by a processor, the steps of the method of claim 1 are implemented.

20. A computer program product comprising computer programs, wherein when the computer programs are executed by a processor, the steps of the method of claim 9 are implemented.
